(19) United States
(12) Patent Application Publication
(10) Pub. No.: US 2006/0010027 A1
(43) Pub. Date: Jan. 12, 2006

(54) Method, system and program product for measuring customer preferences and needs with traffic pattern analysis

(76) Inventor: Paul Jason Redman, Mission Viejo, CA (US)

Correspondence Address: PHILIP H. HAYMOND, 7545 IRVINE CENTER DRIVE, SUITE 200, IRVINE, CA, 92618-2933, US

(21) Appl. No.: 10/887,748

(22) Filed: Jul. 9, 2004

(51) Int. Cl. G06Q 90/00

(52) U.S. Cl. 705/10

(57) ABSTRACT

A method, system and program product for determining movement data of a customer or customers in a store to analyze customer decisions and optimize product presentation and customer service in response to the analysis. The movement of customers through a store may be correlated with various environmental and economic factors to indicate impediments to customers purchasing a product. Product presentation may then be attenuated according to the results of the analysis by removing the impediments or providing incentives to purchase a product, optimally those products sold at higher profit margins, thereby increasing overall store profitability.

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### FIELD OF THE INVENTION

This invention relates to marketing and more particularly to a method, system and program product for optimizing product sales revenues and customer service by tracking customer movement through a store.

### BACKGROUND OF THE INVENTION

The ability to determine and accommodate customer preferences has always been of great importance in the sale of products in stores. Customers may select one product over another for a variety or reasons such as price, utility, alternative products available and ancillary customer service available in connection with a product. Properly determining customer preferences also allows a store to anticipate and deploy employees and other store assets to accommodate customers more efficiently.

The term “store” should be interpreted broadly in this context to include those locations that display a plurality of products for sale that may be selected by a customer. Examples of a store are retail outlets, a warehouse, storehouse or parking lot. Products are typically arranged on shelves along aisles in the store or otherwise grouped with identical products at a single location in the store. Typically a customer enters a store and follows a path as he moves through the store, the customer may select one or more products along that path, then proceed to a checkout location or equivalent to pay for the selected products, where a bill of sale, receipt or equivalent record of the transaction is generated.

One aspect of this challenge is to provide an optimal point-of-sale strategy to induce customers to purchase products when they are making their selections in a store. There is substantial competitive advantage afforded by properly identifying impediments to product sales and measuring the impact of incentives employed to promote the sale of a product. Product sales will likely indirectly benefit from improved customer service as well. Point-of-sale strategies focus on the psychology of the customer, the influence of product presentation on the decision-making process of a customer while he is surveying products in a store, focusing on the decision to choose one product over another.

There are many factors that influence a customer's decision to choose to purchase a particular product from a selection of products. Product price, utility and product alternatives are more manifest factors used by a customer in selecting a given product. Customer service may influence the decision of a customer as well, for example whether additional product information is available when the decision to purchase is being made or whether there is assistance available to prepare or transport a product. More subtle factors that influence a customer's decision include the time of day, fashion trends, the weather, the season and the ability of a product display to catch the eye of a customer, store cleanliness, adequate lighting and signage, to name a few. All of these factors may be the ultimate consideration to induce a customer to purchase a product. Clearly, the ability to accurately measure the results of various strategies to induce product purchases is valuable to a seller.

Many of these factors have been recognized in the past as influencing the decision of a customer to purchase and attenuated by a seller to enhance the attractiveness of products to customers. For example it is well recognized that product placement on a shelf or product position within an aisle can influence a customer's decision. Many stores have adopted the practice of placing higher priced products, cereal for example, at eye level and in the middle of an aisle, while placing lower priced competing products having lower profit margins on a lower, less convenient, bottom shelf.

Another strategy that has been used recognizes that one product may initially attract the attention of a customer and influence the decision to buy another product placed nearby. In response to this stores have adopted various marketing strategies to differentially promote sales of products that generate higher profit margins. A product suffering from a lower volume of sales may be placed near a higher volume product to attract more customers to the lower volume product.

A classic example of this is to place a product sold at a low profit margin but with higher sales volume, a so-called “loss leader”, among alternative products to attract attention and boost sales of more profitable products.

Another exemplary strategy to increase sale of products is to place products having an historically higher volume of sales in a location at the store where potential customers will have to pass other products first, thereby exposing the potential customer to the other products.

Examples of other strategies used to augment product appeal to the customer, referred to herein as product inducements, include intermittent low-price sales of certain products, carrying specialty items to attract a certain demographic of customer, celebrity endorsements, ancillary entertainment or volume discounts.

Another factor in increasing product sales is to remove impediments to sales. Identifying and remediating a sales impediment can be achieved in some instances with a product inducement. A sales impediment, as used herein, is any problem that reduces product sales, it may directly relate to the, price, availability or other quality of a given product, but a sales impediment may also relate to general conditions of the shopping environment, for example adequate parking at the store, adequate lighting, adequate heat and the time spent in a line to pay for the selected products. A sales or product inducement relates to enhancing the presentation, price, availability or other quality of a given product or products to make purchase of that product or products more attractive to a customer. A product inducement is a type of remedial action taken to increase sales, but of a particular product or products.

These strategies have traditionally helped stores increase their revenue and profit margins. The systematic analysis of the success of these various strategies, however, has been imprecise. Strategies used to promote sales may be enormously costly to a seller, so it is imperative that their success be determined accurately. Up to now, the methods and assessment of those methods used by stores to induce customers to purchase higher profit margin products, or more lower margin products, so that the store can maintain an optimal profit margin, has been done using common sense or historical data on past sales of a product over a period of time, collected and analyzed to assess the impact of product placement or other product sales promotion strategies. This data may be roughly correlated to the multitude of factors that may influence a customer's decision to purchase a product to, roughly model the buying experience and response to sales promotion strategies.

These methods reveal the real-time experience of a customer as he makes his way through a store. Path data, the path of the customer or the timing of the journey through a store, which may include time spent lingering in different segments of the path, is highly indicative of customer motivations and aversions. The aggregate path data of shoppers is referred to herein as traffic data or traffic patterns which, if such data were available, can indicate whether there is a specific impediment to sales, generally or at a particular location in the store and the success of various strategies to induce the purchase of products by a customer. Such data might also be correlated to various ancillary factors, such as the weather, relative product placement, product price, the time of day and other exemplary factors, such as those recited above, to determine an optimal product inducement to promote sales of a product.

This same information can be employed to alter sales promotion strategies in real time, for example to present product inducements to respond to apparent customer preferences as they arise. This same information can be employed to accommodate the needs of a store as well, to predict when employees or other store assets will be needed at different locations in the store, as well as indicate in real time the need for more employees and other store assets in the store.

Monitoring a customer's specific path and the amount of time spent lingering at specific locations can therefore be invaluable data to analyze the success of various product sales strategies, particularly as they relate to the physical layout of a store, and physical placement of products.

Path data can be used to allocate store assets such as employees and physical assets, such as carts or forklifts for example by alerting the store management to when a critical mass of customers gathers in a particular area of the store, for example. Store assets could be directed to that area at that time of day to accommodate the needs of customers. Traffic pattern data can be used as well to predict customer needs and allocate these store assets in advance.

What is needed then is a method and apparatus for tracking customer movement to obtain path data during the shopping experience and using that data to determine customer needs and effective sales strategies.

Direct observation of the customers may be used, but this method may meet with objections by the customers as a violation of their privacy. Direct observation of a customer may require that the customer wear a tracking device, which may be perceived by the customer as the electronic equivalent of direct observation. Direct observation may be prohibitively labor intensive as well.

RFID (or radio frequency identification) reader devices may offer a solution. RFID technology is known to those of skill in the art and is exemplified by the Radio Frequency Identification (TI-RFid™) Systems products offered by the Texas Instruments Company, of Dallas, Tex. RFID devices are a combination of radio-frequency-based technology and microchip technology. A typical RFID system includes passive, un-powered tags, sometimes referred to as transponders, and powered tag readers, sometimes referred to as antennas.

RFID technology has been used in the past to track vehicle movement on toll roads, to track vehicles and locations in order to charge varying toll amounts to customers. The collected data from RFID tags has been used to provide trend reports, analysis of traffic flows during rush-hours and impact of traffic flow due to external factors such as weather, public holidays, accidents, toll-rates etc. In the past RFID technology has typically been expensive to deploy, and was used particularly in outdoor environments for example in vehicle and toll applications. RFID technology has however become less expensive and much more widely used in the store environment in recent years. Stores are now using it for inventory control and other purposes, such as tracking purchases with an expedited checkout process at the checkout counter, or for theft prevention.

An optimal solution to this problem then would include an apparatus, method and system for recording the traffic paths and patterns of purchasers during store visits. Customer needs might be met by the path data indicating a customer is waiting for service at a location in the store, or the gathering of a given number of customers, a critical mass, at a given location. The store may deploy additional store assets or employees to that location to attend to the customers.

An optimal system might also be able to correlate the traffic paths to discover traffic patterns. Traffic patterns may indicate impediments to shoppers and could also be correlated to environmental factors such as the date, day, weather, local traffic conditions and the like. After strategies to induce sale of products have been introduced into the store, or a strategy to remediate perceived impediments has been implemented, traffic patterns could be further observed to determine the success of those strategies. Traffic pattern data may also be used to arrange products in such a manner that the greatest profit is realized by the store, and this arrangement may be tested by correlating this data with actual product purchases.

Traffic and path data would also be advantageous because it can be gathered without necessarily using personally identifiable information concerning the customer or otherwise requiring a customer to participate in the data collection process, without causing a customer to feel like he is being directly observed. A preferred solution might also be an automated process to allow the traffic pattern monitoring without costly manual observation.

### SUMMARY OF THE INVENTION

A solution to the above problem has been devised. Customer movement is tracked and recorded to obtain the traffic pattern of customers. Data reflecting individual customer movement is gathered by tracking the movement of an individual customer, referred to herein as path data. Path data includes the locations visited by an individual customer, and may include the amount of time spent by a customer at a location in the store, the time of day a customer spends at a location in the store, and the date a customer spends time at a location in the store. Other location and temporal data of a customer's path is included in the definition of path data as well.

In the preferred embodiment path data including the time and date of the customer's movements and time spent lingering at different locations is included in path data collected. The present invention provides for a software program product that correlates path data to calculate traffic patterns. In the preferred embodiment path data is correlated with products actually purchased by a customer by correlating path data to actual sales transactions to determine whether products have been optimally allocated in the store to both be attractive to the customer, as well as to attract customer attention to other products placed nearby. The movement of customers through a store may also be correlated with various environmental and economic factors to identify impediments to customers purchasing a product and remediated, then further observed to test the success of that remediation. The correlation may also suggest product inducements that can be offered by the store to improve sales of a given product or of products generally.

This observation can be achieved through manual observation or observation with cameras and facial recognition technology. Alternatively a tracking device may be provided to the potential customer to observe their movement. Many types of tracking devices are available to electronically observe and record the traffic patterns of a population of people or other objects. For example wireless cellular, electro-magnetic, geo-positioning systems and electro-optical tracking systems such as SKU bar coding are used to name a few. Use of these devices is considered within the scope of the invention, however in the preferred embodiment an RFID tag and tag reader system is used to track the traffic pattern of customers throughout the store.

An RFID tag is placed on shopping carts and RFID tag readers are placed at intervals in the aisles of the store. The presence of a shopping cart is recorded by the tag reader as the cart moves in proximity to the tag reader.

In this way a customer's traffic pattern may be recorded, without the customer otherwise participating in the process and without the necessity of tracking personally identifiable information concerning the customer, although such a method and system may also include personally identifiable information if desired, for example by noting the identity, age, gender or other factors relating to a given potential customer.

In the preferred embodiment, an RFID tracking device is affixed to an implement provided by the store to the customer to aid the customer while he travels through the store. The most common implement provided by stores to customers is a container provided for a customer to carry products, such as a shopping cart, but other implements might be provided as well, such as a shopping basket or trolley, a personal data assistant, an implement to grasp products or a small vehicle to transport the customer.

As recited above, the preferred tracking device is an RFID tag placed on individual shopping carts and RFID tag readers are disposed throughout the store. RFID systems have enjoyed widespread acceptance in product sales for their economy and ease of use. Their use is expected to be extended to more and more products. In the preferred embodiment, passive RFID tracking tags are placed on shopping implements such as carts and a network of tag readers are disposed at about six foot intervals in the shopping area, especially at the middle and ends the of aisles of a store.

RFID readers are typically much more expensive than RFID tags and require a power source. It is therefore far more economical to place the tags on the shopping implements rather than placing readers on the shopping implements. The presence of the RFID tags placed on the shopping implement is detected as the customer moves through the aisles of a store and the path data is recorded during this movement.

In any system employed the path of a customer is observed and the aggregate paths of a plurality of customers correlated to determine a traffic pattern. Path or traffic pattern data is used to analyze and implement a marketing strategy to increase the profitability of product sales. The collection of data and analysis may be implemented using a computer and a computer program stored on computer readable media including the programming steps of the method described herein.

In the preferred embodiment of the present invention the method for tracking customer shopping paths in a store is by reading RFID identification tags with readers disposed on one or more aisles and identifying the location and the time of each read. Alternatively, the method for tracking a shopping cart may be achieved by placing the readers disposed throughout the aisles to read the identification tags that are placed on products carried by a shopper, and recording the location at which they were read.

Individual path and traffic data may be used for several purposes. With respect to product sales, traffic data may be correlated to actual product sales to identify the success or failure of different product inducement strategies. Individual path and traffic data may indicate problems with particular areas of a store or to correlate traffic behavior with proposed sales variables, factors thought to influence buying decisions, such as product placement in the store, weather and economic data. For example the traffic pattern may be correlated with actual sales. In the preferred embodiment the path data is inputted into a data processing system, referred to generally as a computer, and an optimization report is generated. An optimization report correlates path data and product sales. It can be generated by the computer with appropriate programming. Ideally the data will be recorded directly from the electronic tracking device to obviate the need for any human data collection or calculation.

The results of the optimization report can then be used to remediate sales impediments, aisle conditions for example, or implement product inducements to improve product sales, for example by adjusting product placement on the shelves of an aisle, offering product discounts at a given store location based on a traffic pattern optimization report. A traffic pattern optimization report may suggest impediments to sales or show relatively underutilized areas of the store. A traffic pattern optimization report may also test that area after an impediment has been remediated after a product inducement has been implemented for example. For example, by adjusting product placement inventory, where the inducement is a product experiencing a high volume of sales, to induce customer purchasing of a product experiencing an undesirably lower volume of sales, the change in traffic pattern and actual sales of given products can be correlated to determine the success of that strategy.

Another example of an inducement that may be employed is to offer a discount coupon related to a product.

Another inducement that may be used is to offer information relating to the product experiencing an undesirably lower volume of sales when a customer is in proximity to that product. This information may be presented to the customer at that location, for example with a video display.

A specific marketing strategy may be to place a product experiencing a low volume of sales but sold at a high profit margin near a product that historically experiences a high volume of sales. In this way sales of the product having a low volume of sales can be increased from the greater customer attention paid to the neighboring product having a high volume of sales.

The system and method of the present invention may also be used to allocate store assets such as employees and physical resources, forklifts for example. For example the identification tags may be read and correlated to detect when a critical mass of customers have aggregated in an area of a store, then directing employees to that area, or by then making physical resources more available to that area of the store to accommodate the increased number of customers. Traffic data may also be used to predict when a location within the store may need additional store resources or employees. In the program product and software implementation of the present invention, the critical mass number is predetermined according to the preferences of the user. The location of the store assets may be monitored as well by placing tracking devices on those assets.

In summary, in the preferred embodiment RFID tags are placed on the shopping carts of a store. A number of RFID tag readers are also disposed along the aisles of the stores, at intervals of six feet for example. As customers push the carts through the store the RFID tag readers record when an RFID tag is brought into proximity to an RFID reader. The record of the RFID tag read is recorded as path data by a data processing system. The path of a customer can be implied from the order of sequence of the tag readers that have read the passing cart. The amount of time spent lingering in a given location can be implied by either multiple reads from a tag reader, or by subtracting the actual time it takes for a customer to move a cart from a first tag reader to a second tag reader.

In the preferred embodiment the path data is recorded by a data processing system, a computer, and may be used for several purposes. It may be used to indicate when a customer needs assistance, by lingering in a given location for example. The method of the present invention may be implemented on the data processing system to combine individual path data to obtain traffic pattern data, to predict day, date and other factors that can be used to predict when store assets such as employees should be stationed in a particular store location.

The traffic pattern data can also be used to calculate the average time spent at a given location in the store, or a preferred path. This traffic pattern data may suggest underutilized areas of the store and suggest further investigation by the user to determine why that area is underutilized, whether there is an impediment at that location such as poor lighting, too few attractive products, etcetera. An optimization report correlating traffic patterns before and after remediating an impediment, or before and after implementing a product inducement, may be generated to measure the success of a strategy to increase actual sales, correlating actual items purchased to different store locations.

Before explaining at least one embodiment of the invention in detail it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is a diagram of a store and an exemplary path taken by a customer in a store.

FIG. 2 is a diagram of a store and an exemplary traffic pattern taken by customers in a store.

FIG. 3 is a diagram of a prior art RFID system.

FIG. 4 is a diagram an embodiment of an RFID tracking device used to track customers in a store.

FIG. 5 is a diagram showing the use of an embodiment of the present invention.

FIG. 6 is a flow chart of a method of the present invention.

FIG. 7 is a diagram of a computer that may be used to collect path data and correlate traffic pattern data.

### DESCRIPTION OF THE INVENTION

The following description, and the figures to which it refers, are provided for the purpose of describing examples and specific embodiments of the invention only and are not intended to exhaustively describe all possible examples and embodiments of the invention.

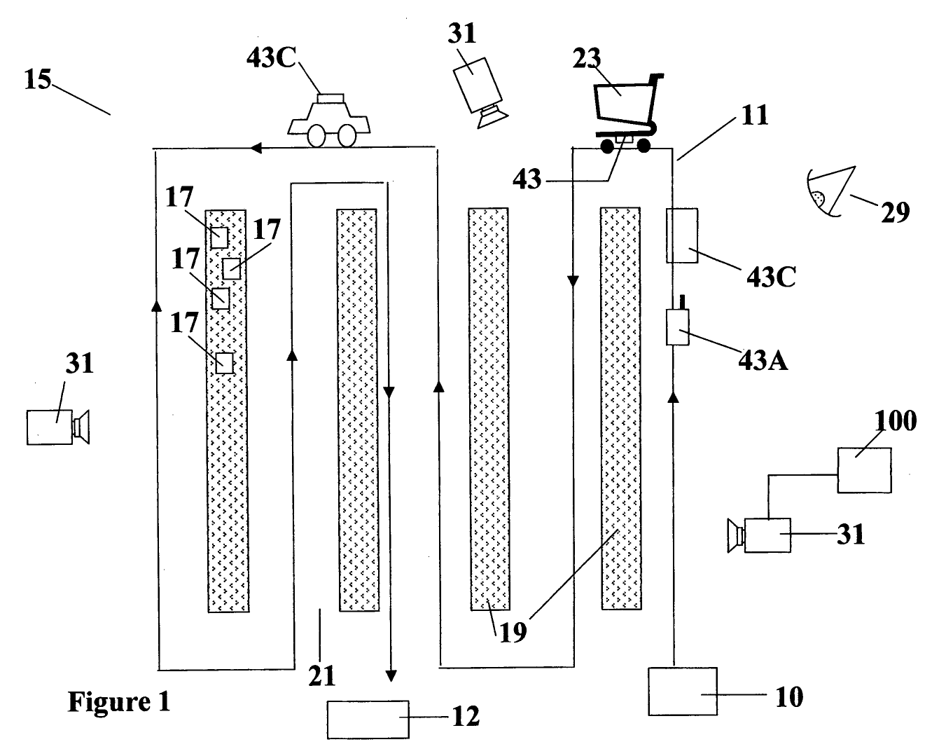

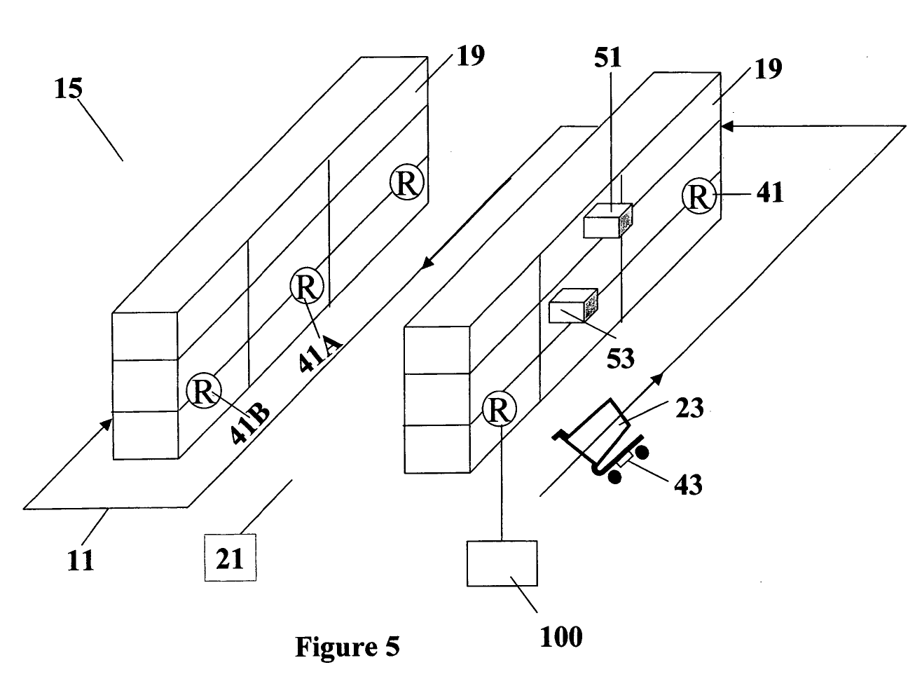

Referring now to FIG. 1, the path 11 of a customer in a store 15 having products 17 arranged on shelves 19 in aisles 21 is shown. In a typical scenario the customer path is from the store entry 10 where a cart 23 is obtained by the customer, to the checkout 12. The customer pushes a cart 23 through the store 15 to evaluate products 17 placed on the shelves 19 (shown in FIG. 5) of aisles 21. The products 17 are illustrated on an aisle for emphasis, but they are distributed along all the aisles 19 in this example, perhaps on shelves (shown in FIG. 5). Observing this path 11 may yield at least three types of path data, the location of the route taken by the customer; the time of the route and the time spent at various locations throughout the route. The shopper may linger at locations in the aisles 21 where products 17 of interest to the customer are located.

In the prior art stores would attempt to simply attract customers to higher profit margin items so that the store can make a reasonable overall business margin. This was done using common sense, an example of this might be the fact that higher priced cereal may be placed at eye level, and the low priced, low margin cereal may be on the bottom shelf. These strategies have traditionally helped stores increase their revenue and margins. A careful analysis of path data and traffic data however, can reveal a better profile of customer psychology in response to environmental conditions or sales terms and reveal appropriate product inducements that may be placed at different locations in the store to induce increased traffic for increased product sales.

In one embodiment of the present invention the paths taken by customers may be observed manually by an observer 29 situated at a vantage point that allows him to observe customer traffic and record and correlate it manually as well. Alternatively a group of cameras 31 could be placed at different locations in the store and the customers tracked by a display (not shown) or by connecting the cameras to a central data processor 100, a computer, and tracked with the use of facial recognition software. In this embodiment a new customer face could be recorded on the data processing unit 100 upon entry to the store by a first camera and, much like the preferred embodiment, the path of a customer could be implied from the order of the sequence of when a customer is recognized by subsequent cameras. The time spent lingering in an area could be calculated by subtracting the time at which a customer face was recognized at a first camera, from the time at which the face is recognized at a second camera.

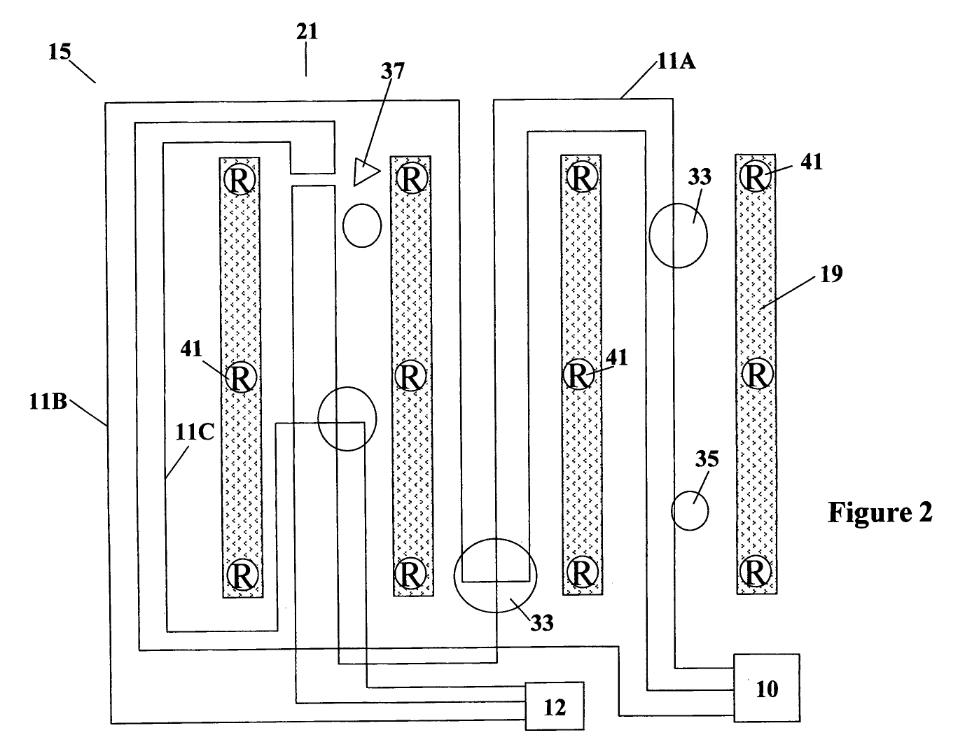

Referring now to FIG. 2, the paths of a plurality of customers 11A, 11B and 11C may be correlated to determine traffic patterns of customers. For example, locations where customers disproportionately linger in proximity to products may be determined and are termed herein hot spots shown at 33, the size of the circle being proportionate to the average amount of time spent by customers lingering there. A hot spot, combined with data reflecting few actual purchases at that location, may indicate that an item is not being purchased, it may indicate a problem because a customer is lingering over the product deciding whether to purchase it. Conversely, locations in proximity to products that customers disproportionately avoid are termed cold spots, shown at 35 by way of example. A cold spot, combined with data reflecting many actual purchases at that location, may indicate a quick decision to buy, meaning that the price might be increased on that product. This data may be calculated for all products in the store. In this way the user can determine whether it would be advisable to modify item placements, offer discounts to increase sales, and other strategies such as offering a loss leader to attract traffic and increase sales of other products that are nearby. The path data may also reveal locations where a disproportionate number of customers reverse direction in an aisle, termed turn spot, shown at 37. As indicated above, such traffic data can be used for several purposes. With respect to product sales, traffic data may be correlated to actual product sales to identify the success or failure of different product inducement strategies. Individual path and traffic data may indicate problems with particular areas of a store or to correlate traffic behavior with proposed sales variables, factors thought to influence buying decisions, such as product placement in the store, weather and economic data.

In the preferred embodiment the path data is inputted into a data processing system, referred to generally as a computer and an optimization report correlating path data and product sales is generated by the computer with appropriate programming. Ideally the data will be recorded directly from the electronic tracking device to obviate the need for any human data collection or calculation.

In the preferred embodiment RFID tag readers 41 (also indicated by the letter R) are disposed throughout the store, at the ends and middle of aisles. Preferably the tag readers are placed within about six feet of each other, preferably at the ends of each aisle. An RFID tag 43 is affixed to shopping carts 23 provided for customer use, but may be affixed to any other shopping implement provided by the store for customer use, such as a personal digital assistant 43A, an implement to grasp products 43B or a small vehicle to transport the customer 43C. Newer RFID tag readers have become an affordable tracking solution. RFID technology is known to those skilled in the art. Tracking shopping carts 23 with RFID technology allows a similar utility to tracking vehicles on a toll road. In this case the tracking vehicles are deployed within the internal environment of a store, however. This technology allows real-time tracking of customers within a store which facilitates resource allocation and also allows trend and optimization analysis to be performed on aggregate data.

Placing RFID readers at or near the point of sale, using a cash register at the checkout location for recording the sale, or a similar point of sale device, and integrating the system into an RFID point of sale device allows a customer path to be related to the exact products purchased by the customer traveling that path.

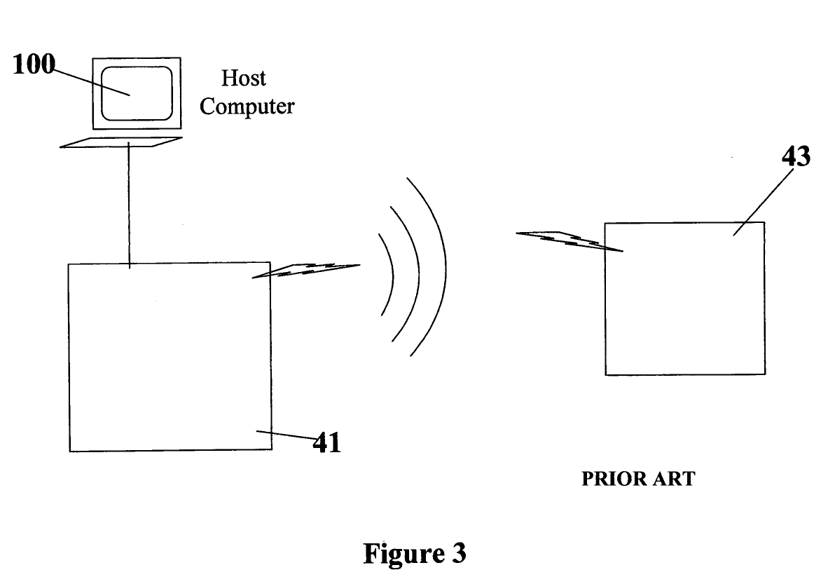

FIG. 3 shows an exemplary RFID system of the prior art. A typical RFID system has three components, RFID tags 43, also referred to as transponders, that are electronically programmed with information concerning the product to which they are attached; readers or sensors 41 to interrogate the tags, also referred to as antennas; and 100 a computer or server on which software records the tags as they are read. The information contained on microchips in the tags affixed to products is read using radio frequency technology. RFID tags are already fairly ubiquitous: they are used on products, on ID badges and by commuters on toll roads that pass readers that pick up a unique signal from an RFID tag placed on each car.

The tags used in RFID technology are preferably un-powered, the power to read the tags comes from the reader. The tags are the backbone of the technology and come in all shapes, sizes and read ranges including thin and flexible labels which can be laminated between paper or plastic. An RFID system creates an automatic way to collect information about product and path data, the location and time.

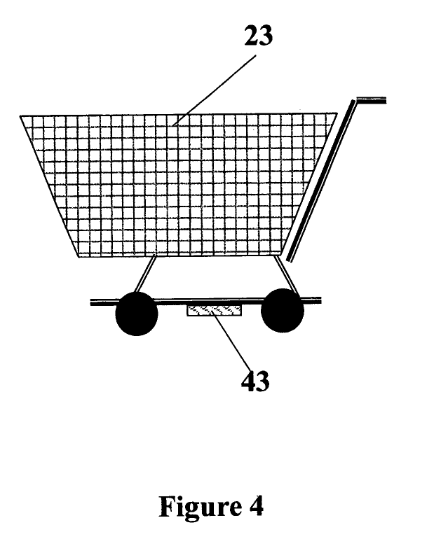

FIG. 4 shows use of an RFID tag reader as used in the preferred embodiment of the present invention, in conjunction with the RFID tag system of FIG. 3. A tag 43 is placed on a container, here a shopping cart 23.

As shown in FIG. 5 the shopping cart 43 can be read by typical tag readers 41 (also shown by the letter R) when the tag and tag readers are in close proximity, about six feet, generally disposed at the ends and in the middle of aisles 21 of the store 15. In one method when a customer moves a cart past a tag reader 41A and path data is recorded, the path 11 shown in direction of arrows, which includes the location of the tag reader and may include other path data such as the time of day and the date. The duration of how long a tag is read by a tag reader can be used to indicate how long a customer lingered just next to that tag reader. When the user passes a second tag reader 41B it may be implied that the customer moved in a path from the location of the first tag reader to the location of the second tag reader. The time of the first read may be subtracted from the time of the second read to calculate the time spent in the area between to two tag readers.

The preferred embodiment of the present invention also includes the data collection process that tracks customer paths using RFID technology, correlates that data to the products purchased, and an optimization report generated by computer system can be used to optimize the stores product sales, increase margins and remove impediments to a customer buying a product.

For example, by knowing exactly where the highest volume of customers travel at a particular time on a particular day, or by knowing based on the weather and historical data, such customer activity as when the customers will be going to the ice-cream or winter coat aisle can be predicted. The store can put higher margin products at that location and increase its revenues. It is a sales axiom that the more customers you reach the more product you will generally sell. This may be of great advantage over previous methods for collecting sales data. Without this information it is more difficult to optimize sales.

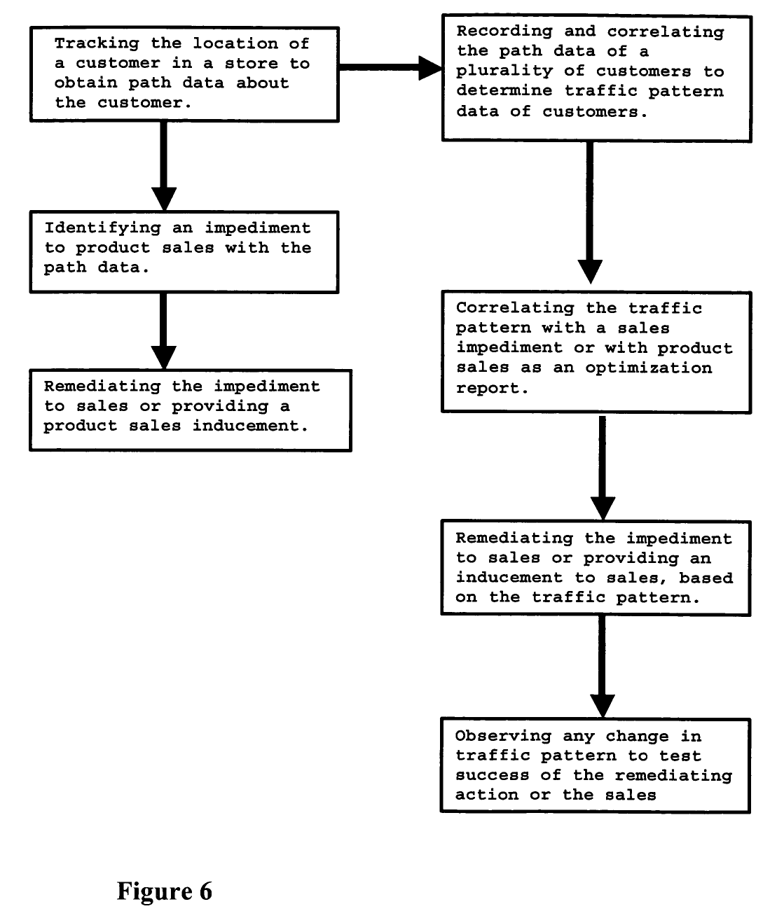

FIG. 6 is a flow chart of an embodiment of the method of the present invention, which may be executed by program product executed on a data processing apparatus. A store customer is tracked to obtain path data about that customer. The path may identify an impediment to product sales, such as lingering in an area near a product that requires assistance. An appropriate remedial action is then implemented, such as sending an employee to assist the customer. Tracking a plurality of customers to obtain their path data and correlating the path data of the plurality of customers results in a traffic pattern for customers. A sales impediment, such as low sales of some products due to environmental conditions may be identified by the traffic pattern in an optimization report. The user may then implement remedial action or offer an inducement to product sales based on the traffic pattern. Further tracking and observation of any change in the traffic pattern may be used to test the success of the remediating action or the sales inducement.

The Path data or a traffic pattern may be correlated to increase sales, to remediate sales impediments or to facilitate sales by using product inducements. Path data may be used in real time to remediate impediments purchasing products. For example the path data of a customer of time and location may be used to send an employee to the location where a cart has been sitting for too long a time to determine if the customer needs assistance. The path data of location may be used to send a store asset, such as an employee or a forklift to locations where a customer will ultimately need assistance, such as purchasing lumber or goods that need to be moved, prepared or packaged, such as lumber, paint or loose items such as nails.

Real time traffic data is the correlation and averaging of a plurality of paths taken by customers. Traffic pattern information can be used to predict path behavior and anticipate the need to allocate store assets, such as employees, to a particular location in the store.

Traffic pattern information can be obtained and used for any store having a plurality of customers, with products located at different locations in the store. It includes the steps of recording the path data of a plurality of customers, path data includes all attributes solely related to a customer's path, such as location of a portion of the path taken by a customer in the store; the amount of time spent by a customer at a location in the store; the time of day a customer spends at a location in the store; or the date a customer spends at a location in the store. The path data for a plurality of customers is then statistically correlated to determine a customer traffic pattern of the store. This statistical correlation may be as straightforward as averaging the paths to indicate a predominant path.

The observation and recording can be implemented by electronically tracking the path taken by a customer in a number of ways. There are several tracking technologies available, as detailed above, but it is preferred to use an RFID tracking device of FIG. 4, where the RFID tag is placed on a shopping implement, generally a shopping cart, that is moved by one or more of the plurality of customers.

Tags and tag readers may be provided, in the preferred embodiment the tags and tag readers are RFID tags and RFID tag readers.

In the preferred embodiment path data is entered into a data processing device, a computer and calculated by the computer to generate an optimization report. The optimization report is a report that correlates the traffic pattern with any proposed variable relating to the sale of a product, such as an environmental variable or the price of a product.

Optimization reports may be used to suggest appropriate remedial measures to be taken to remove impediments to sales, or to suggest affirmative inducements to product sales. The optimization report may further be used to test for sales impediments that are thought to have been corrected, or to see whether sales inducement strategies are successful.

For example, correlated information can be used to correlate disproportionate lingering next to a particular product with sales of that product. This might indicate something as trivial as poor lighting in an aisle. This might also indicate that although the product is attractive to customers it might be too expensive. Remedial measures might include a sale, a discount coupon, or only offering it during times of the year when customers will likely be willing to spend the full amount. Other products themselves may be used to alter traffic patterns, such as the loss leader described above as one example.

Path data or a traffic pattern may be correlated to increase sales, to remediating sales impediments or to facilitate sales by using sales inducements. Path data may be used in real time to remediate impediments purchasing products. For example the path data of a buyer of time and location may be used to send an employee to the location where a cart has been sitting for too long a time to determine if the buyer needs assistance. The path data of location may be used to send a store asset, such as an employee or a forklift to locations where a buyer will ultimately need assistance, such as purchasing lumber or goods that need to be moved, prepared or packaged, such as lumber, paint or loose items such as nails.

A more sophisticated optimization report might compare an aisle of products based on calculating the profit margin of products in that aisle, the quantity of products actually sold in that aisle and the net revenue made from that aisle. A product inducement strategy might be implemented by placing an inexpensive impulse item in the aisle to cause the customer to linger longer near higher profit margin items. Am alternative exemplary product inducement strategy might be to provide information through a communications device, such as a video display 51 or dispense a related discount coupon 53.

The present invention relates to methods, systems and a program product for use with a computer, also referred to as a data or digital processing system herein.

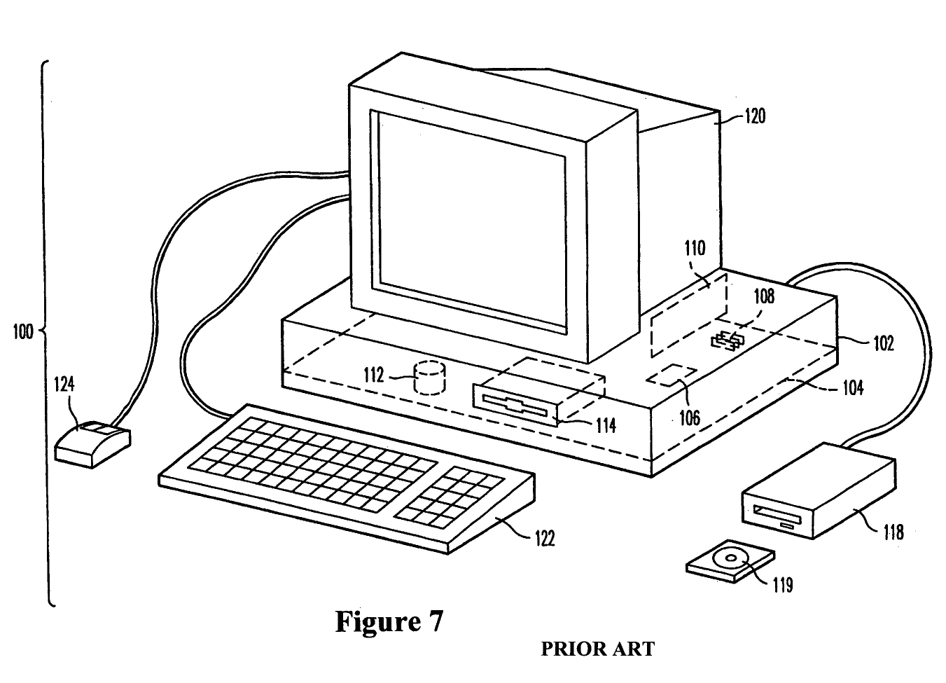

In a preferred implementation, the computer is embodied in a data processing system such as that depicted as 100 in FIG. 7. FIG. 7 is a block diagram of an exemplary computer system for implementing the methods of the present invention. A general purpose computer 100 implements the method of the present invention, wherein the computer housing 102 houses a motherboard 104 which contains a CPU 106, memory 108 (e.g., random access memory (RAM), dynamic ram (DRAM), static RAM (SRAM), synchronous DRAM (SDRAM), flash RAM, read-only memory (ROM), programmable ROM (PROM), erasable PROM (EPROM), electrically erasable PROM (EEPROM), or any other desired memory), and other optional special purpose logic devices (e.g., application specific integrated circuits (ASICs)) or configurable logic devices (e.g., generic array of logic (GAL) or reprogrammable field programmable gate array (FPGA)). The computer 100 also includes one or more input devices (e.g., a keyboard 122 and a mouse 124) and a display card 110 for controlling a monitor 120. In addition, the computer system 100 further includes a floppy disk drive 114; other removable media devices (e.g., a compact disc 119, a tape, and a hard disk 112, or other fixed, high density media drives, connected using an appropriate device bus (e.g., a small computer system interface (SCSI) bus, an enhanced integrated device electronics (IDE) bus, or an ultra direct memory access (DMA) bus). Also connected to the same device bus or another device bus, the computer 100 may additionally include a compact disc reader 118, a compact disc reader/writer unit (not shown), or a compact disc jukebox (not shown). Although compact disc 119 is shown in a CD caddy, the compact disc 119 can be inserted directly into CD-ROM drives which do not require caddies. In addition, a printer (not shown) also provides printed listings of any of the inputs, intermediate values, and outputs associated with the models of the methods of the present invention. Other peripheral devices may include additional computer systems via local or wide area networks and the Internet, and which may further include such peripheral devices as printers, facsimile machines, scanners, network connection devices, tape drive units, etc.

The system includes at least one computer readable medium used for storing computer instructions, program product. Examples of computer readable media are compact discs 119, hard disks 112, floppy disks, tape, magneto-optical disks, PROMs (EPROM, EEPROM, Flash EPROM, etc.), DRAM, SRAM, SDRAM, etc. Stored on any one or on a combination of computer readable media, the present invention includes software for controlling both the hardware of the computer 100 and for enabling the computer 100 to interact with a human user. Such software may include, but is not limited to, device drivers, operating systems and user applications, such as development tools. Such computer readable media further includes the computer program product of the present invention, in accordance with the description above or any of the examples below.

The computer code devices of the present invention can be any interpreted or executable code mechanism, including but not limited to scripts, interpreters, dynamic link libraries, Java classes, and complete executable program which when executed, perform the methods of the invention. The method can be implemented as a software program using a variety of programming languages, such as Simula, C++, Visual Basic or Java, by programming techniques known to those of skill in the art. Thus, the present invention may be implemented on a machine, such as the general purpose computer 100, that transforms data (representing path or traffic data and relating them to proposed marketing variables) to achieve a practical application.

In conjunction with the data processing system 100, the undertaking as described here is implemented by successively adding increasingly detailed customer path information to a database which may be retained on computer-readable media of the system. The data is processed by one or more programs executed by the CPU 106 which are designed to analyze the proffered data against various models and previously stored data related to customer path or traffic as will be subsequently described herein. Accordingly, the process interrelates these programs and data to present customized solutions.

It will be appreciated that the invention has been described hereabove with reference to certain examples or preferred embodiments as shown in the drawings. Various additions, deletions, changes and alterations may be made to the above-described embodiments and examples without departing from the intended spirit and scope of this invention. Accordingly, it is intended that all such additions, deletions, changes and alterations be included within the scope of the claims.

What is claimed is:

1. A method for utilizing traffic pattern data of customers comprising the steps of:
providing a store having one or more products, each offered for sale at a price, the products are located at different locations on one or more paths in the store for customers to traverse to select the products,
recording the path data of a plurality of customers, said path data comprising the location of a portion of the path taken by a customer in the store and/or
the amount of time spent by a customer at a location in the store and/or
the time of day a customer spends at a location in the store and/or
the date a customer spends at a location in the store, then,
statistically correlating the path data of the customers to determine a traffic pattern of the store.

2. The method of claim 1 where the observation and recording is implemented by electronically tracking the path taken by a customer.

3. The method of claim 1 where the path data is entered into a computer.

4. The method of claim 1 where the path data is entered into a computer and correlated with product sales with the computer.

5. The method of claim 1 wherein the electronic tracking is a tracking device having a component that is moved by one or more of the plurality of customers.

6. The method of claim 5 where the tracking device comprises a tag and a tag reader.

7. The method of claim 6 where the tag reader reads the tag when the tag and tag reader are in close proximity.

8. The method of claim 6 where the tag reader is an RFID tag reader, the tag is an RFID tag affixed to products in the store.

9. The method of claim 6 where the tag is affixed to a shopping implement moved by the customer.

10. The method of claim 9 where the tag reader is an RFID tag reader, the tag is an RFID tag affixed to the shopping implement.

11. The method of claim 9 where the shopping implement is a container for carrying products in the store.

12. The method of claim 10 where a plurality of RFID tag readers are placed at different locations in the store.

13. The method of claim 1 further comprising the step of taking a remedial measure to increase the sales of a product.

14. The method of claim 13 where the remedial measure includes moving the location of one or more products.

15. The method of claim 13 where the remedial measure includes changing the price of one or more products.

16. The method of claim 13 where the remedial measure includes moving the location of a store asset.

17. The method of claim 16 where the store asset is a store employee.

18. The method of claim 1 further comprising the steps of correlating the relationship between traffic pattern data and the sales volume of a product, and taking a remedial measure to increase the sales volume of a product based on the correlation.

19. The method of claim 18 where path data further includes recording which products were purchased by one or more individual customers.

20. The method of claim 18 where the remedial measure includes moving the location of one or more products.

21. The method of claim 18 where the remedial measure includes changing the price for one or more products.

22. The method of claim 1 further including the steps of observing the location of one or more store assets and moving one or more store assets to a store location in response to traffic pattern data predicting that an average number of customers exceeds a critical mass of customers at the store location at a given time of day.

23. The method of claim 22 where one of the one or more store assets is an employee of the store.

24. The method of claim 1 further including the steps of observing the location of one or more store assets and moving one or more store assets to a store location in response to traffic pattern data predicting that an average number of customers exceeds a critical mass of customers at the store location on a given date.

25. The method of claim 24 where one of the one or more store assets is an employee of the store.

26. The method of claim 24 further including a tracking device affixed to one of the store assets and the observation of that store asset is achieved by following the store asset with the tracking device.

27. The method of claim 26 where that store asset is an employee of the store.

28. The method of claim 24 wherein a tracking device is affixed to one or more store assets and further including the steps of recording the location of one or more store assets and moving one or more store assets to a store location at a time of day in response to traffic pattern data reflecting that the average number of customers at that store location exceeds a critical mass of customers at that time of day.

29. The method of claim 28 where one of the one or more store assets is an employee of the store.

30. A method for increasing sales of a product in a store, comprising the steps of:
providing a store having one or more products and the products are located at different locations on one or more paths in the store for customers to traverse to select the products,
tracking the location of one or more customers to obtain path data, said path data comprising
the location of a portion of the path taken by a customer in the store and/or
the amount of time spent by a customer at a location in the store and/or
the time of day a customer spends at a location in the store and/or
the date a customer is at a location in the store, and, recording the information.

31. The method of claim 30 where an electronic tracking apparatus is used to track the customer.

32. The method of claim 31 where a component of the tracking device is moved by the customer.

33. The method of claim 32 where the tracking device comprises a tag and a tag reader.

34. The method of claim 33 where the tag reader reads the tag when the tag and tag reader are in close proximity.

35. The method of claim 31 where the path data is entered into a computer.

36. The method of claim 33 where the tag is an RFID tag that is placed on a product in the store.

37. The method of claim 30 further comprising the step of taking a remedial measure to increase the sales volume of a product based on a location of a customer and/or a product.

38. The method of claim 37 where the remedial measure is to provide additional information about a product at a location in the store.

39. The method of claim 38 where the information provided the customer is determined by whether other products are moved in the store by the customer.

40. The method of claim 35 where the tag is an RFID tag and the reader is an RFID reader that is affixed to a shopping implement moved by the customer.

41. The method of claim 40 where the shopping implement is a container for carrying products in the store.

42. The method of claim 37 where the remedial measure is moving one or more store assets to a store location in response to a critical mass of customers being in substantially the same location.

43. The method of claim 42 where one of the one or more store assets that is moved is an employee of the store.

44. The method of claim 42 wherein a tracking device is also affixed to a store asset and further including the step of moving that store asset to a store location in response to a critical mass of customers being in substantially the same location.

45. The method of claim 44 where the store asset that is moved is an employee of the store.

46. A system for gathering traffic pattern data of customers, comprising:
in a store having one or more products offered for sale at a price, where the products are located at different locations on one or more paths in the store,
an electronic tracking device that can track the path of one or more customers while they are in the store.

47. The system of claim 46 wherein the electronic tracking is a tracking device having a component that is moved by the one or more customers.

48. The system of claim 47 where the tracking device comprises a tag and a tag reader.

49. The system of claim 48 wherein the tag reader reads the tag when the tag and tag reader are in close proximity.

50. The system of claim 48 where the tag reader is an RFID tag reader, the tag is an RFID tag affixed to products in the store.

51. The system of claim 48 where the tag is an RFID tag that is affixed to a shopping implement moved by the customer.

52. The system of claim 51 where the tag reader is an RFID tag reader.

53. The system of claim 52 where the shopping implement is a container for carrying in the store products selected by a customer.

54. The system of claim 52 where a plurality of RFID tag readers are placed at different locations in the store.

55. The system of claim 46 further comprising data processing apparatus executing programming steps including the steps of:
recording inputted path data of a plurality of customers in the store, and/or
statistically correlating the locations of the paths taken by the customers.

56. The system of claim 55 further comprising the steps of correlating the relationship between traffic pattern data and the sales volume of a product, and
taking a remedial measure to increase the sales volume of a product based on a correlation.

57. The system of claim 55 where path data further includes recording which products were purchased by one or more individual customers.

58. The system of claim 57 where the recording of the sales of a product is implemented by interfacing with a point of sale device.

59. The system of claim 58 where the electronic tracking device interfaces with the data processing apparatus and automatically correlates the path with the sales indicated by the point of sale device.

60. The system of claim 59 where the electronic tracking device is an RFID reader located in close proximity to the point of sale device.

61. The system of claim 58 where the data processing apparatus further correlates additional data with the correlated path and sales data.

62. The system of claim 59 where the additional data indicates profit margins for products in different locations of the store.

63. A program product, comprising:
a storage device readable by a data processing apparatus and tangibly embodying a program of instructions executable by the data processing apparatus to perform method steps for customer path data, the method steps comprising:
providing a data processing apparatus to record inputted path data of a plurality of customers in a store having one or more products, each offered for sale at a price, the products are located at different locations in the store and the path data comprises
the location of a portion of the path taken by a customer in the store and/or
the amount of time spent by a customer at a location in the store and/or
the time of day a customer spends at a location in the store and/or
the date a customer spends at a location in the store.

64. The program product of claim 63 further including the step of correlating path data of a plurality of customers to determine average path data.

65. The program product of claim 63 wherein the program product has instructions to interface with an electronic tracking device that can track the path of one or more customers while they are in the store is used to input data to the data processing device.

66. The program product of claim 65 wherein the electronic tracking is a tracking device having a component that is moved by the one or more customers.

67. The program product of claim 66 where the tracking device comprises a tag and a tag reader.

68. The program product of claim 67 where the tag reader reads the tag when the tag and tag reader are in close proximity.

69. The program product of claim 67 where the tag reader is an RFID tag reader, the tag is an RFID tag affixed to products in the store.

70. The program product of claim 67 where the tag is affixed to a shopping implement moved by the customer.

71. The program product of claim 70 where the tag reader is an RFID tag reader and the tag is an RFID tag.

72. The program product of claim 71 where the shopping implement is a container for carrying in the store products selected by a customer.

73. The program product of claim 71 where a plurality of RFID tag readers are placed at different locations in the store.

74. The program product of claim 63 further comprising the step of correlating the relationship between traffic pattern data and the sales volume of a product

75. The program product of claim 74 further comprising the step of taking a remedial measure to increase the sales volume of a product based on the correlation.

76. The program product of claim 74 further comprising the step of testing for a change in path data when a remedial measure to increase the sales volume of a product is taken, where that remedial measure is based on a correlation between product sales and path data.

77. The program product of claim 74 where path data further includes recording which products were purchased by one or more customers.

78. The program product of claim 77 where the program further includes instructions to record the sales of a product by interfacing with a point of sale device.

79. The program product of claim 78 where the program further includes instructions to cause the data processing apparatus to automatically correlate the path data with the sales indicated by the point of sale device.

80. The program product of claim 79 further including instructions to correlate additional data with the correlated path and sales data.

81. The system of claim 80 where the additional data indicates profit margins for products in different locations of the store.
